(19) United States
(12) Patent Application Publication
(10) Pub. No.: US 2015/0196982 A1
(43) Pub. Date: Jul. 16, 2015

(54) CNC MACHINING CENTER FOR MACHINING EXPANDED MATERIALS

(71) Applicant: Michele CABONI, Oristano (IT)

(72) Inventor: Michele Caboni, Oristano (IT)

(21) Appl. No.: 14/363,827

(22) PCT Filed: Dec. 7, 2012
(86) PCT No.: PCT/IT2012/000370

§ 371 Date: Jul. 7, 2014

(30) Foreign Application Priority Data
Dec. 9, 2011 (IT) TO2011A001130

(51) Int. Cl. B23P 23/02; B26F 3/12; B26D 1/04; B26D 3/00; B29C 44/02; B23C 3/00

(52) U.S. Cl. CPC B23P 23/02; B29C 44/02; B23C 3/00; B26D 1/04; B26D 3/006; B26F 3/12; B29K 2025/06

(57) ABSTRACT

A compact machining center CNC is described, equipped with hot cutting blades and cutting and milling tools, for machining of foamed materials and/or extruded or other materials in general, comprising at least a first station (1) comprising: at least one castle (11) adapted to contain at least one block (a) of expanded polystyrene, EPS, for processing; at least one frame (5) adapted to carry at least one hot cutting dies (6); at least two slides (14) for milling performed by a tool (15) mounted on at least one electro-spindle (16) for each slide (14), the milling tool (15); and at least one frame (20) wire port/s (21) complete with insulators (22) and devices (23) for fixing and tensioning wires (21).

### FIELD OF THE INVENTION

The present invention relates to a compact machining center (CNC), equipped with cutting blades hot pre-shaped dies and cutters, for the processing of any foamed material like phenolic foam or extruded materials in general, in particular for panels of any ICF (insulated concrete foam) thick, with a complex geometry (hereinafter for brevity called “machine”).

### DESCRIPTION OF THE PRIOR ART

Conventional pantographs for continuous cutting of expanded polystyrene plates (flat surfaces even if not perfectly coplanar in its facades) are known in the art, such as the numerical control cutting line machine, Model ECO IV 4000 M 2000 manufactured by DDL LTD. Such slabs, however, have no specific application for the building industry, since, as currently designed, by heating the wires of such pantographs, the resulting slabs from the cut are not suitable for environmentally friendly industrialized construction applications. For example to build modular elements with corrugated surfaces, micro-ribbed elements with longitudinal grooves and undercuts lattice, with negative and—positive female-male, male-male, female-female dovetails in their facades, with unlimited shapes and geometry, even the most disparate.

However, historically and currently in the building industry around the world all ICF panels (mainly from the US and other countries) are to be always printed smooth facades, limited in sizes medium in size and no more than 0.30/40 cm in height, and thicknesses defined, through specific aluminum molds suitably molded and shaped for the purpose, and for this reason serve multiple molds to produce obviously a range of standard panels ICF. However briefly and not exhaustively specified first, means that you can produce panels with ICF Technical Note molds, obviously with a thickness defined heights and lengths standardized by means of a single aluminum mold.

In fact, to produce said panels ICF confront very high investments for the multiple molds needed for single thickness, height and defined length not more than 150 centimeters. It becomes obvious that a note of technology not only implies similarly high costs due to the remarkable timing—of molding if these panels ICF if they have to be produced in thicknesses higher average heights of 40 cm and a maximum length of 1500 cm. More disadvantageous becomes the production of these panels ICF above the same, co-molded with plastic inserts PP, or integrated spacers at least in two panels facing each other between them, through complex molds associated with conventional printers adequate and modified for the purpose, which are also very costly and not easy to find in industry and in the world market.

The present invention the rapid manufacturing of elements of any geometry with complex shapes and more December Also without bond materials, and in Particular the realization of panels in ICF (EPS) foam and/or (XPS) of any extruded shape, extent length, height and thickness,’ and indeed having multiple measurements with submultiples INSULATED CONCRETE FORM called term international (ICF SYSTEM), contrary to the common conception of molding obsolete and static part to get the same products made by the machine in question with the classical technique of molding static, it would take a large number of high performance molds and technology, Which in any case would never allow you to print certain ICF panels or decorations in general, and an equal number of special printing machines, combined with bells Conveying the steam to the specific mold type for allow them to make my notes sintering of virgin EPS beads, with obvious and consequent high investment.

Moreover, the machines used for the molding of the panels ICF present in the industries and on the world market are not always adaptable to complex technical molds.

From all this, are deduced the extreme and exclusive dynamism and the elasticity of the machine in question, either as the capacity and type of production, both as variability of composition depending on the product to be cut and/or milling, whether formwork modular cables for the creation of flights of stairs in the site, hollow blocks, panels of any thickness, height and length, having the same cavity to “T” or of any conformation necessary for the perfect coupling of more elements of any type of materials they are, cornices, string courses, decorative capitals and jambs for doors and windows, arches door box thermal roller-blinds and anything else needed to create these elements in monolithic form.

Advantageously and exclusively the Machine produces panels ICF tapered striped with quarries obtained both in the facade internal and/or external or jointly with hollow “T” and/or “cross”, for accommodating any type of connector is necessary for the conjunction of a plurality of components for the conformation of any formwork-formwork for a perfect housing bound of structural profiles, longitudinal rods. and the stirrups horizontal is placed in tilt, pitch and variable geometry, in accordance with the known technique of armor steel, in order to perform advantageously and exclusively all current and future regulations at the international level.

However, as seen, the known machines for cutting polystyrene and similar material are only a heated wire for “Joule effect” by means of electrical energy, and fail to realize a cut coplanar and perfect, especially when working elements and/or panels over the meter linear. Therefore, the complete machining of the few elements that will be unable to realize would lead to costs and times that are acceptable.

### SUMMARY OF THE INVENTION

The purpose of the present invention is to construct a modular machine according to requirements, able to work quickly, and that it is constructively very simple and inexpensive in the model base, with a very high operating speed and exclusively polyhedral, because of the unique technology applied based on wires and multiple punches shaped heated “Joule effect” using electricity in the most varied shapes and many cutters shaped for the purpose, all controlled by CNC system and software.

The work center described below realizes, by a block (A) of parallelepiped shape of EPS expanded polystyrene and/or size of the extruded from the classic standard sizes from 400×100×120 cm or of other measures arranged in a vertical position (the machine can also be constructed for working in horizontal and/or inclined, and the dimensions of the block (A) are not binding, because the machine can adapt to the dimensions of the block (A) constructed by the user, given that his inventive feature is the ‘extensibility of the frame with obvious replacement of the screws (or belt) transmission in the extending direction), the panels having. integrated quarries and ICF/or undercuts with dovetails variable geometry (in thickness and height), which are indispensable elements for solidarity and perfect assembly of a formwork-formwork-related bottom floor and pot of any size (linear, angular shaped cavity attached).

This machine is designed for cutting and milling the necessary panels for the construction of specific elements, for foundations, thermo-insulating external and internal walls, panels or slabs for floors, sloped roofs, macro-ventilated roofs, micro-ventilated roofs, decorative elements such monolithic hollow columns, monolithic string courses, cornices, decorative capitals, door insulation for doors and windows, thermal box roller-door-shutters, arches, arches and rest in order for the construction of buildings for private, public and industrial sectors.

The execution of the foregoing, even in many different forms, can be cut to die in hot (single and multiple) linear and shaped, hot-wire (single and multiple) linear and also shaped in many different shapes, milling with suitably shaped tools. The machining systems cited (hot cutting and milling) can succession sequentially or simultaneously, and always according to a sequence controlled by a numerical control (CNC system) slaved to the machine, in which are implemented the various processing cycles programmable via software specific trade or specifically designed for these features.

The above and other objects and exclusive advantages of the invention, as will appear from the following description, are achieved with a compact machining center CNC system equipped with blades and dies by hot cutting and milling tools, for machining, made from the same materials expanded or extruded in general, as described in claim 1. Preferred embodiments and non-trivial variations of the present invention are the subject of the dependent claims.

It is understood that all of the appended claims form an integral part of the present description.

### BRIEF DESCRIPTION OF THE DRAWINGS

The present invention will be better described by some preferred embodiments, given as an example and not limitative, with reference to the accompanying drawings, in which:

FIGS. 1 to 10 illustrate a first variation of the machining center of the present invention;

FIG. 11 illustrates a second variation of the machining center of the present invention;

FIGS. 12 to 15 illustrate a third variation of the machining center of the present invention;

FIGS. 16 to 18 illustrate a fourth variation of the machining center of this invention;

FIGS. 19 and 20 illustrate a fifth variation of the machining center of the present invention.

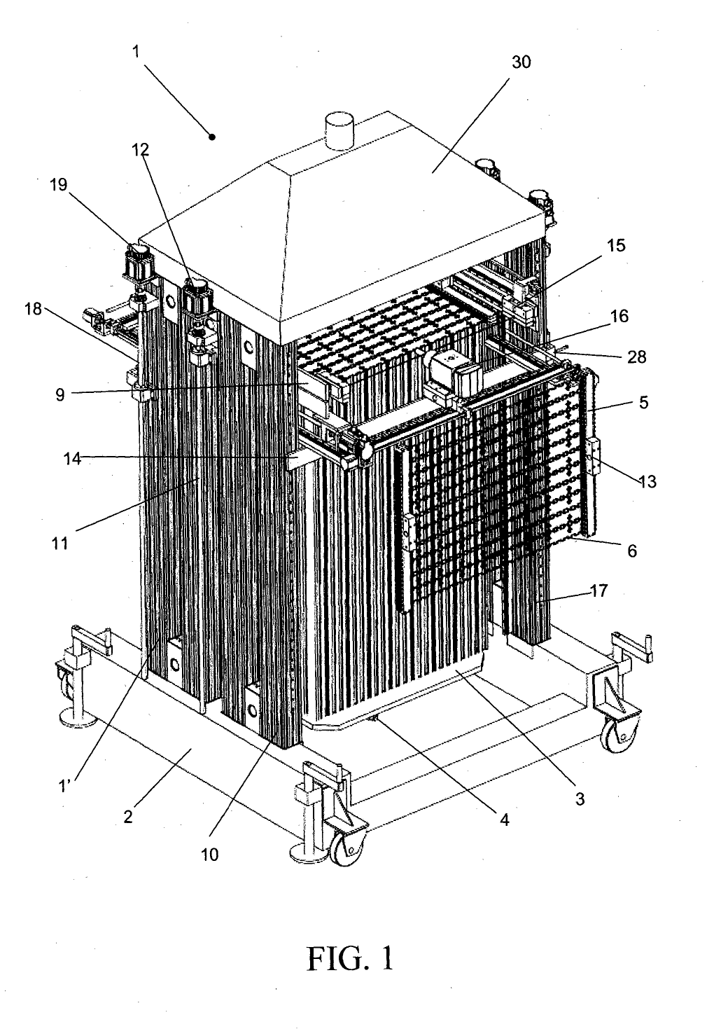

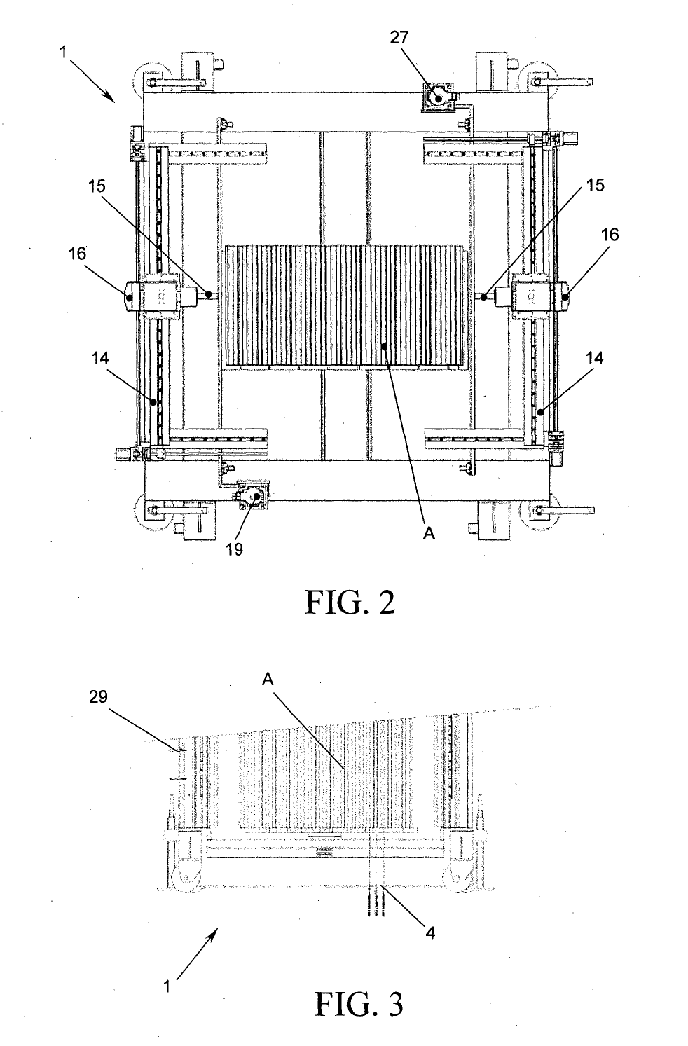

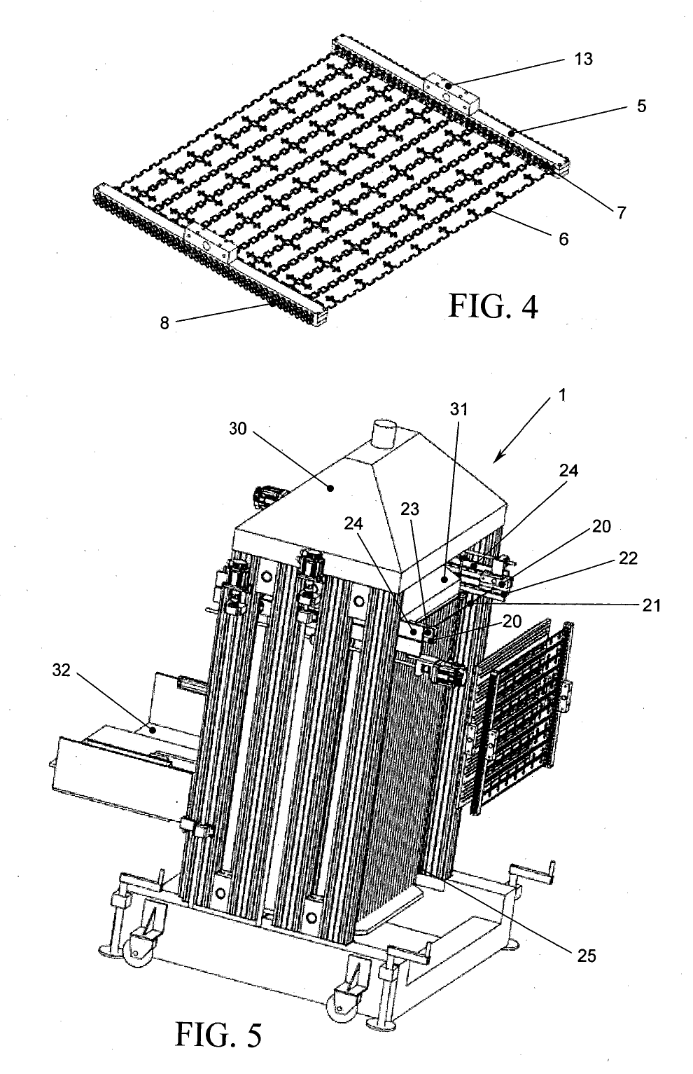

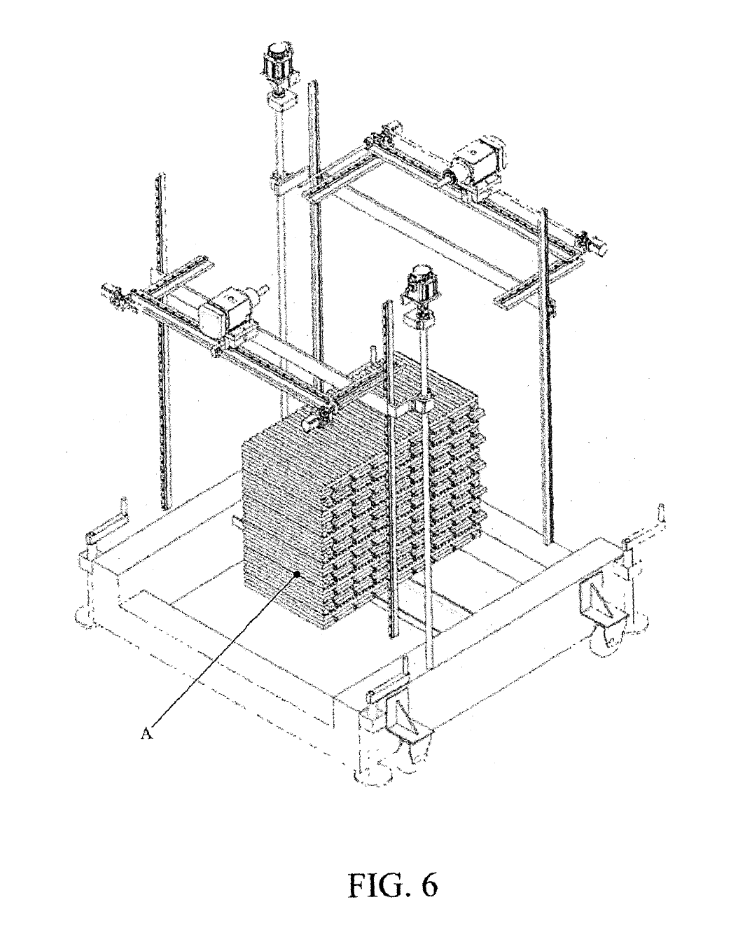

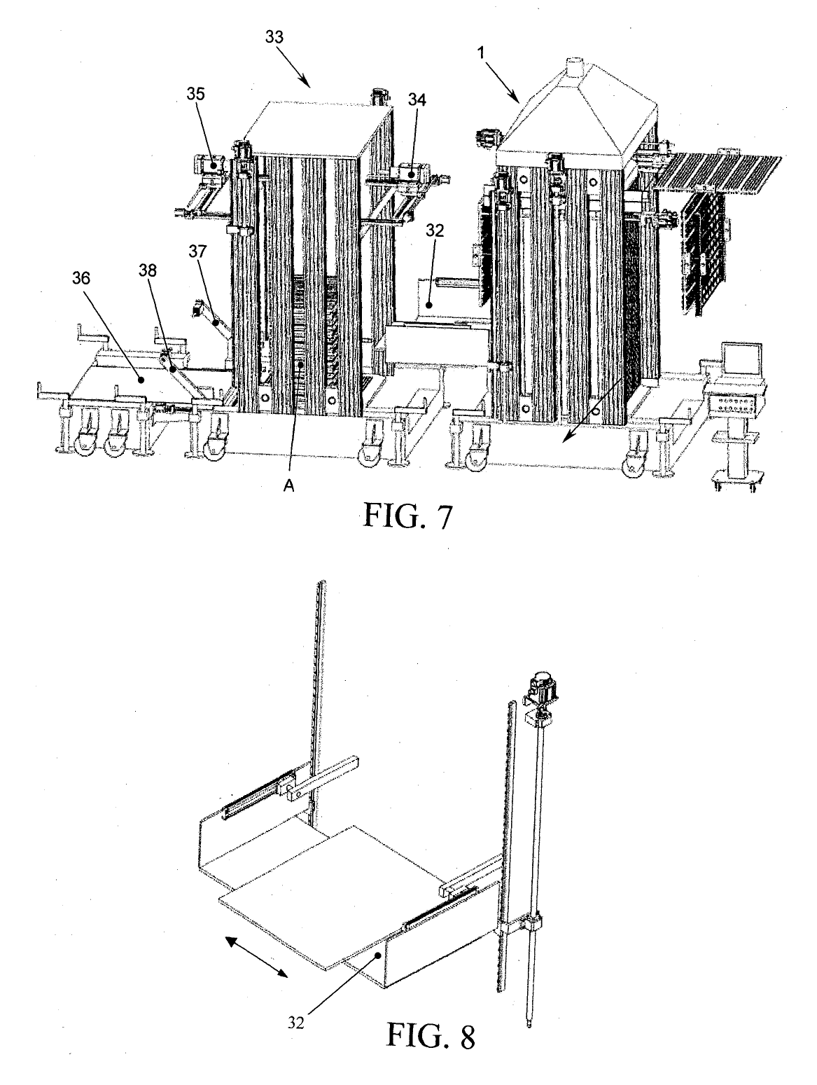

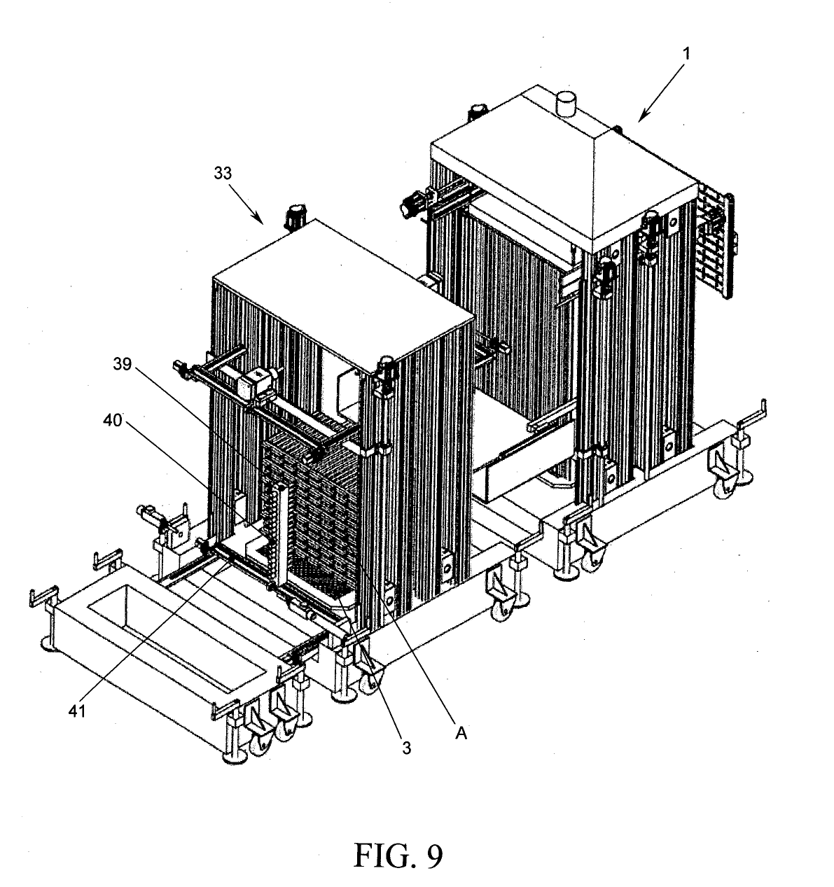

### DETAILED DESCRIPTION OF REPRESENTATIVE EMBODIMENTS

Referring to the Figures is illustrated and described a preferred embodiment of the machining center of the present invention. Be immediately obvious that it will be possible to make what is described numerous variations and modifications (for example related to shape, design, sizes, arrangements and parts with equivalent functionality) without departing from the scope of the invention as appears from the appended claims.

As regards the processing of the panel linear, it has variable dimensions from a minimum of size 120×15 (H)×5 (D) cm to 120×60 (H)×30 (P) according to multiples of 15 cm for (H) and 2.5 cm to (P). This panel may present various types of grooves; including the preferred is the one dovetail. On the facades 120×H, are linear grooves or polygonal-lattice alternate male and female sides 120×P, linear grooves alternate male and female sides H×D.

The machine for the machining of said panels in EPS polystyrene foam or other foam materials or gummy of any density is constituted by a first station (1) comprising a bunk (1′) to vertical uprights having longitudinal grooves supported by a base (2) that accommodates a supporting surface (3) equipped with electro-pneumatic cylinders (4).

The block (A) of EPS polystyrene, by means of a belt or a roller conveyor, is placed in a vertical position on the floor (3), centered with respect to the castle (1′)• In the upper part of this, are placed various types of tools (punches, wires, cutters) in the order described below starting from the floor (3):
a frame (5) carrying hot cutting dies (6) complete with insulators (7) and devices (8) clamping and tensioning frames. The tines may be fixed or movable to adapt to the thickness of the panel to be realized, even in the most disparate conformations (formwork modular cables for the. creation, of flights of stairs in the site, hollow blocks, panels of any thickness, height and length, having the same cavity “T” or any conformation necessary for the proper attachment of most elements of any material they are, cornices, string courses, decorative capitals and jambs for doors and decorative windows, arches and arches, seismic thermal containers, thermal containers door shutters). The wagon door-frame (9) slides on linear guides (10) of known construction placed inside the uprights (1′). and is moved vertically by means of a screw, driver (11) (or also with pulleys and belt) and motor (12); on said carriage (9) is located a movement (analogous to 10-11-12) which allows the frame (5) to move in the horizontal direction to escape from the castle (11) in so that they can be manually positioned at an angle from 0° to 90° thanks to a hinge graduated (13) interposed between the carriage (9) and the frame (5) for performing cutting along directions and angles as desired. Above the dies (6) are placed metallic foils unheated and. not shown on the drawing, having the same shape of the hot cutting dies. (6), that prevent the narrowing of the opening of the panel immediately after passing through the cutting die (6) by heating with integrated wire nickel cadmium, so as to prevent an increase of resistance to cutting and any change of direction of the same;
two slides (14) for milling performed by a tool (15) mounted on an electro-spindle (16). The slides (14) opposing slide on linear guides (17) of known construction placed outside of the uprights (1′) and are moved vertically by means of a screw driver (18) (or also with pulleys and belt) and motor (19); on these slides (14) is placed a handling (analogous to 10-11-12) that allows the displacement of the step necessary for the realization of the grooves or slots. The machine being saved by CNC system, the cutter can move in interpolation according to the vertical and horizontal directions so as to perform a milling inclined and/or according to a curvilinear profile. Can be mounted to each slide (14) over an electro-spindle (16) for contemporary grooves without limitation conformation;
a frame (20) wire port/s (21) complete with insulators (22) and devices (23) for fixing and tensioning wires. The wires may be fixed or movable manually or by a motor of known construction, to adapt to the cutting to be performed. The carriage (24) which bears the frame (20) slides on linear guides (25), of known construction, placed outside of the uprights (l′J and is moved vertically by means, of a screw transmission without end (26) (or also with pulleys and belt) and motor (27); on said carriage (24) is placed a handling (analogous to 10-11-12) which allows the frame (20) to move in the horizontal direction for make the cut to the. pitches you want without restriction. The machine being saved by CNC, the wire/s (21) can move in an interpolation according to the vertical and horizontal directions so as to perform an inclined cut and/or according to a curvilinear profile.

Using a single wire (21), the cutting operation in horizontal begins as soon as the door frame punches has exceeded the safe altitude and the grooves have been carried out by the drills, all programmed using software designed for this purpose.

As previously mentioned, the block (A) in polystyrene foam EPS rests on a table (3) equipped with electro-pneumatic cylinders (4) bearing rod end a sphere self-supporting. The latter, activated by CNC depending on the format of the panels to be machined, protrude from the table (3) and raise the block (A) in EPS polystyrene so that the frame (5) that carries the hot cutting dies (6) can escape completely from said block (A) at the end of the vertical cut. The table (3) can be equipped with rotary motion with respect to its axis: in fact, in the execution of assailable elements to a cylinder (columns), once effected the cut with the cutting dies (6), it may be necessary to perform milling with corners predetermined to be performed with the electro-spindles (16).

For the maintenance of the cut panels on the sides of the castle (1′) opposite the entrance and exit of the block (A) in polystyrene EPS foam, are arranged in the vertical direction of the electro-pneumatic cylinders equipped end of the stem of appendices pointed (28) or suction cups (29) that intervene CNC controlled only after the passage of the frame (5) carrying the hot cutting dies (6) and are deactivated at the end of all the workings.

Starting from the top, the panels which are completely machined can be evacuated from the work area through special gripping devices, of known construction, combined with the machine and operated by the same CNC.

In the upper part of the bunk (1′) are placed a suction hood (30) of the fumes generated by the cutting die (6) and thread, and a counter-hood (31) for maintaining constant the temperature of the dies and the wires hot.

From the above description, it is clear. that, in the end, the used panels are missing on the sides of the grooves 120×P and P×H. For this through a dedicated and specific mechanism (32) to translate and tilt (consisting of gripping arms self-centering by means of electro-pneumatic cylinders, translating always by means of electro-pneumatic cylinders, and made to rotate through electro-pneumatic cylinders rotating) the group of panels is brought into a second station (33) where, through the mechanisms of milling (34) and (35), said panels undergo the execution of the grooves on the sides 120×P. The mechanisms (34) and (35) are similar to kinematic milling described for the first station. Subsequently, the group of panels is traversed with thrust mechanisms not shown on a carpet and/or roller conveyor (36) where, through the mechanisms (37) and (38), said panels undergo the execution of other processes. The mechanisms (37) and (38) are each constituted by a rotating arm (0°-180°) motorized carrying one or more electro-spindles mechanically adjustable in position along the direction of the arm itself to vary the geometry of the machining; of arms, in addition to the rotation, are equipped with a movement parallel and perpendicular to the direction of the carpet and/or roller conveyor (36) by means of kinematic mechanisms motorized analogous to those described above.

Such devices allow to perform, in addition to grooves on the sides D×H, millings variable geometry for the realization of arcs, arches and decorations with recesses. of any shape and design, even the most disparate. The two arms (37) and (38) are independent in operation and still managed by CNC. The panels in the two working operations are kept perfectly in place by fighting specific measurement variable captures not shown in the drawing, controlled by photocells connected to the CNC system.

The second station (33) can be also equipped with rotary table (3), a support (39) carries electro-spindles (40) arranged vertically with manual mechanical variation of distance between the one and the other (mechanism consisting from the adjusting screw and locking by means of bolts not shown in the drawing) and is moved in the horizontal direction by means of the kinematic mechanism (41) similar to 22/11/10, and performs the milling on one side P×H; subsequently, after having carried out the rotation of the table (33), repeats the processing on the other side P×H. Since the rotary table can be milled with the work piece oriented according to different angles in a simple and easy.

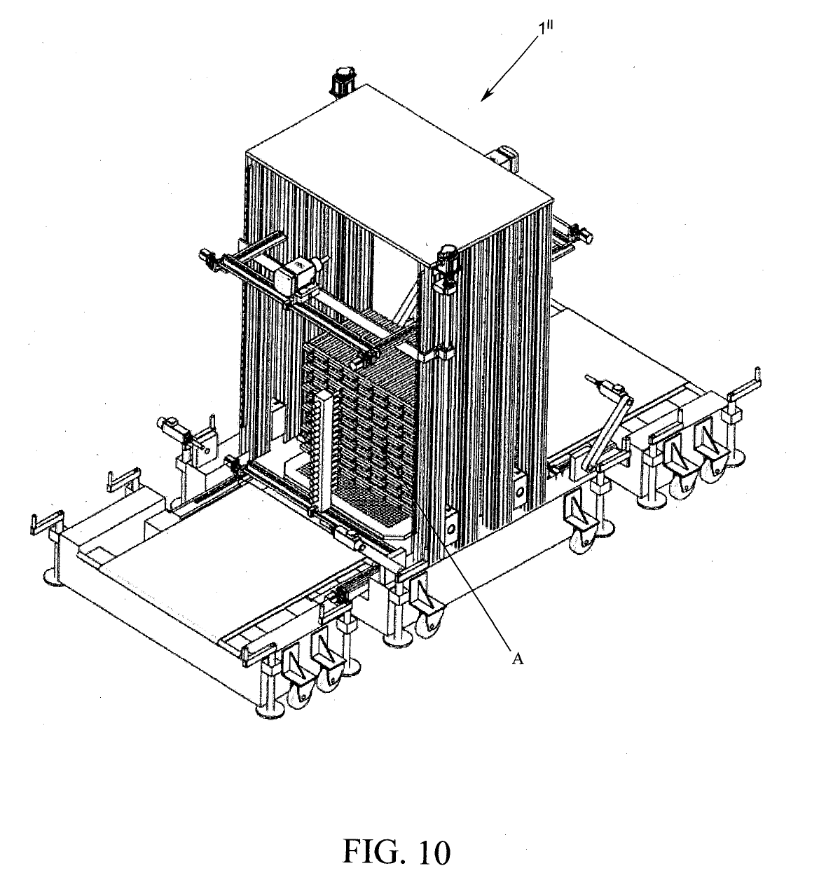

The inventive machine may, as a variation of the first station (1), provide for a station (l1 1) as shown in FIG. 10, without kinematic hot cutting dies (6) and multiple wire/s with kinematic milling multiple entry and exit to the grooving, emptying and decoration panels had been cut and/or other architectural elements such as decorative elements such as monolithic hollow columns, monolithic string courses, cornices, decorative capitals, jambs seismic insulation for doors and windows, to ribs decorative elements for all sixth string courses, door bins thermal-blinds, round-headed arches, etc. The two kinematic milling, are independent and move transversely to the direction of translation of the pieces. The electro-mill-holding spindles can vary the distance with respect to one another by means of an adjusting scre and securing bolts as previously described.

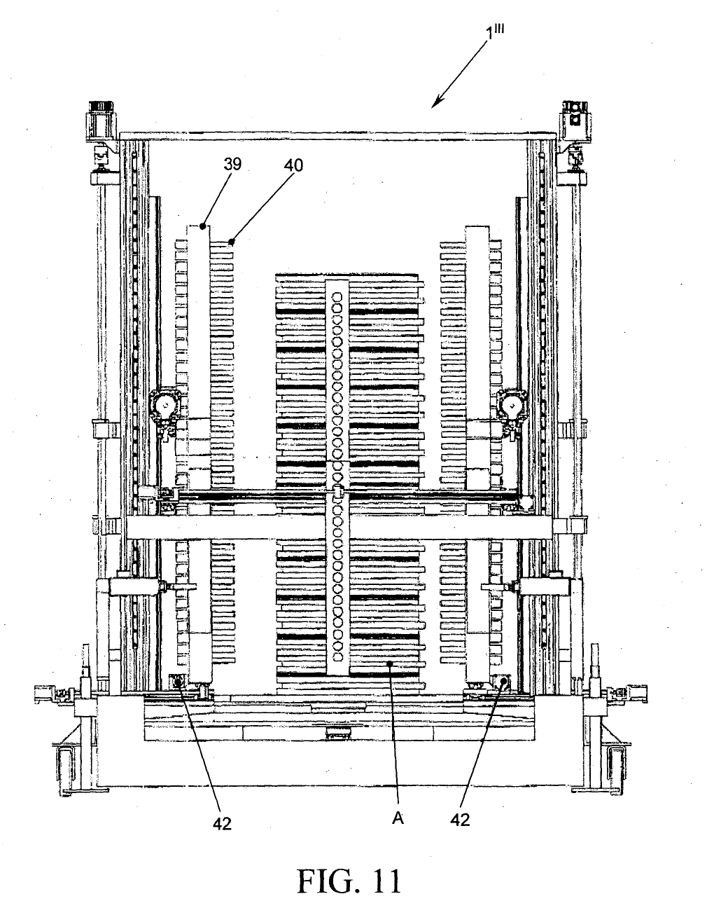

As illustrated, in FIG. 11, it can be noticed a variation (1′V′) of the first station without kinematic hot cutting dies (6). and—multiple wire/s with kinematic milling on four sides for the realization of grooves, emptying and decorations on a block (A) whole panels previously cut and other architectural elements such elements for ‘assembling formwork modular cables for creating flights of stairs on the site, hollow blocks, panels of any thickness, height and length, with the same cavity T or any conformation necessary for the perfect engagement more elements of any material they are, which, cornices, string courses, decorative’ capitals and jambs for doors and decorative windows, arches and arches, door bins thermal shutters and quant—‘another is to create these elements in monolithic form for in-formwork of hollow columns, monolithic string courses, cornices, decorative capitals, door insulation for doors, and windows, roller shutters thermal-door, round-headed arches decorative elements for string courses, ribs in arches etc. The support table of the material can be rotated and all movements are controlled by CNC.

The supports (39) leads electro-spindles (40), independent of each other and arranged vertically with manual mechanical variation of distance between the one and the other (known mechanism consists of the adjusting screw and locking by means of bolts) are moved by means of kinematic mechanisms (42) similar to those previously described.

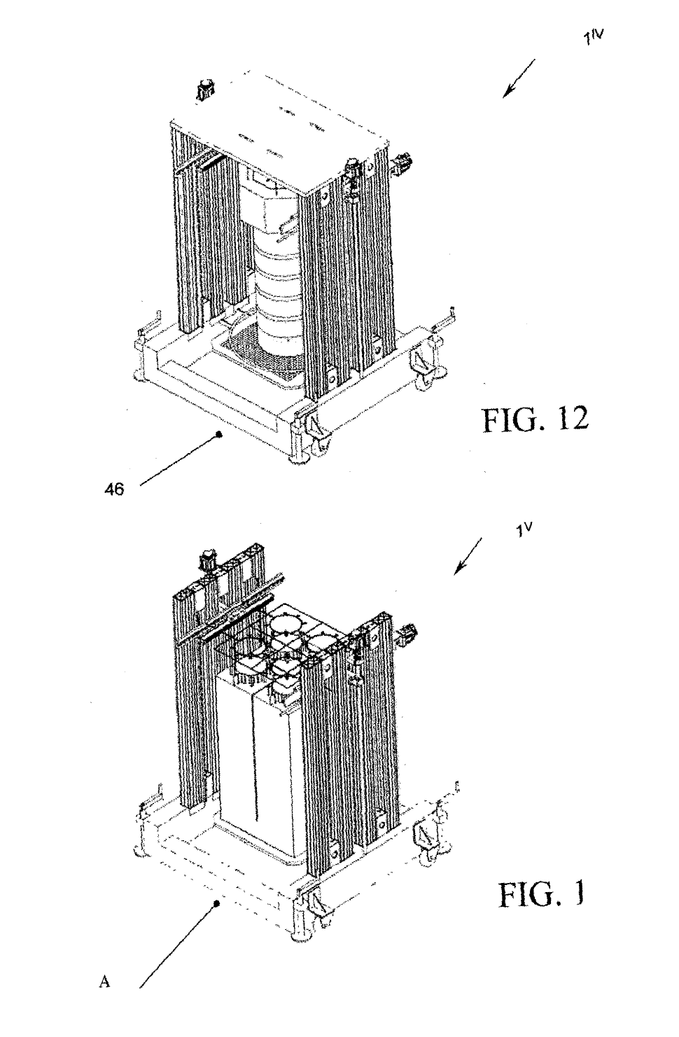

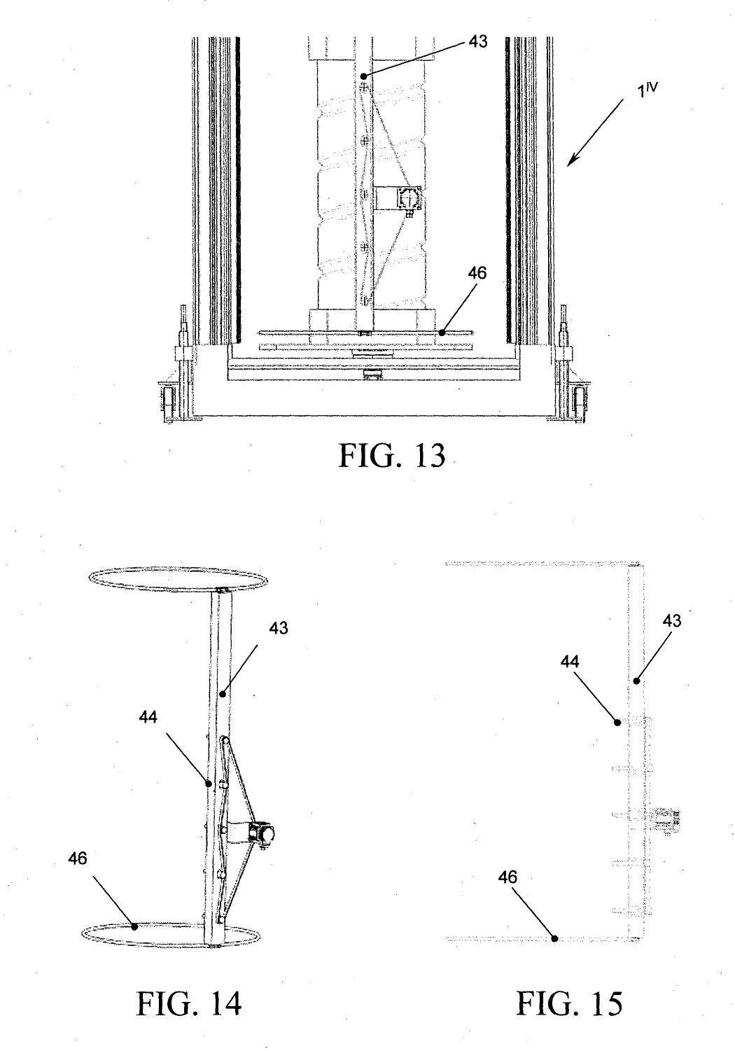

As illustrated in FIGS. 12 to 15, is depicted a variation (lib) of the first, station only with multiple kinematic cutting dies (6) for the execution of the emptying of a column and with a support (43) which leads cutters (44) arranged vertically, with manual mechanical variation of distance between the one and the other (known mechanism consists of the adjusting screw and locking by means of bolts), driven by belt and pulleys by a single motor, said support moved by kinematic linear similar to those previously described or angular (46) by means of rack and pinion (not shown), for the execution of the decorations on said column without any limit of machining at any angle and depth.

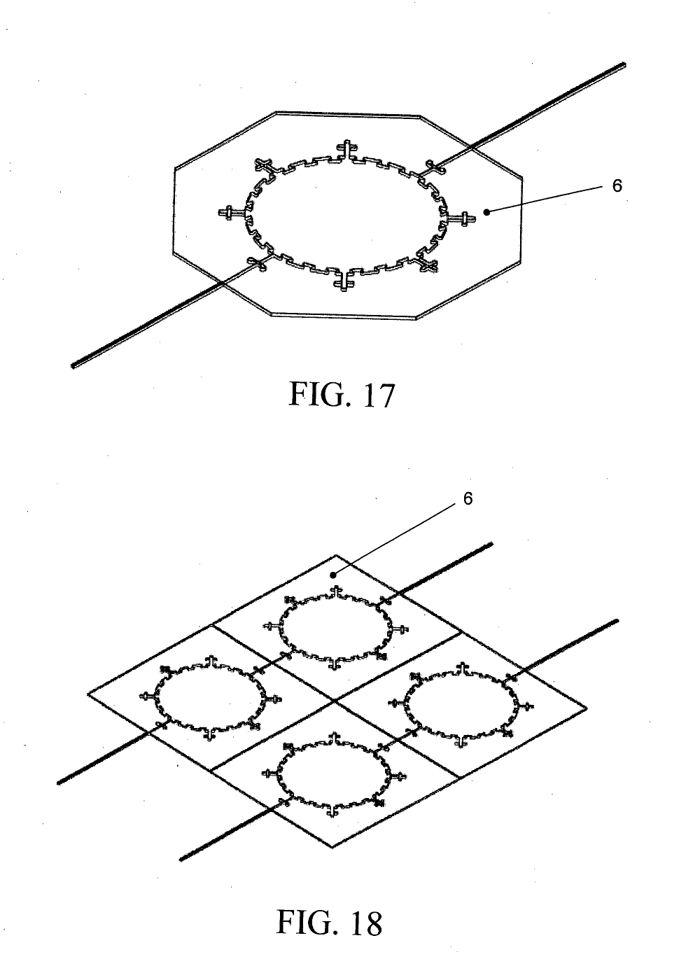

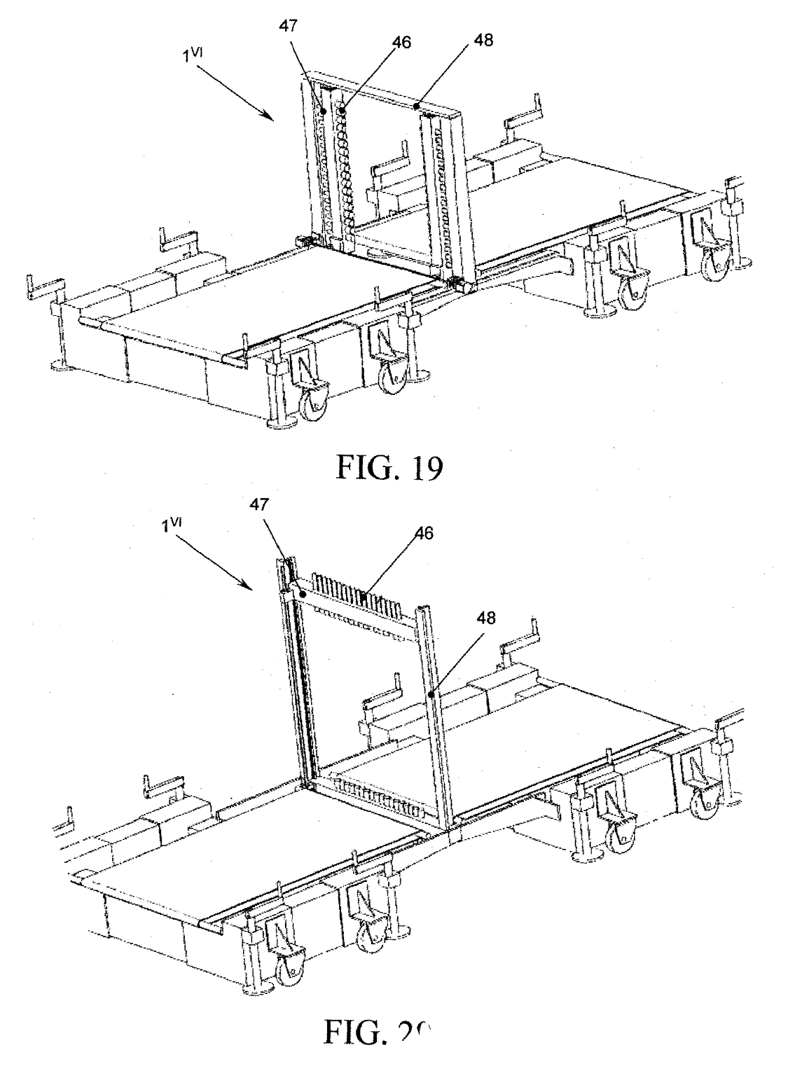

According to the variation (IV) of FIGS. 16 to 18, there is illustrated the first station only with multiple kinematic cutting dies (6) (FIGS. 17 and 18), for the execution of the emptying from one to four columns of conformation also different drawing. The interior design of any geometric shape even the most disparate back however the dovetail grooves and slots “T” or “cross” for housing any type of connector/spacer necessary for the conjunction of the semi-columns and the ‘housing bound the longitudinal rods and the stirrups horizontal variable pitch. The data obtained for cutting and emptying have the function of a special formwork-disposable formwork for building constructions monolithic, with a procedure advantageously innovative and not known.

A software application is also provided, which is a program of CAD-CAM. to be installed directly on the server machine and/or in a workstation external and networked with that server, and in any case in a remote connection with the head office management.

The 2D/3D CAD system is implemented in an application specific structured as follows:
proprietary database of all the elements producible, enabled archiving files only authorized, not modifiable by the user, but recalled from these for the production of the most varied types of panels, plates ICF, special pieces-elements that make up any type of formwork-caissons insulation. Each new creation desired by the user shall be subject to the authorization of a data processing center in remote connection, viewing the drawing; the program will act in order.
Nesting algorithm that allows, given the size of the block (A) to be worked and the type of the element to make (and/or elements provided they are compatible with one another for tools), the optimization of the material by reducing waste to a minimum of material
Automatic generation of the cycle, defined as a sequence of operations to be performed and the tool path.
View and monitor the various phases of work.
Monitoring and parts counting performed, it cannot be altered by the user, using alphanumeric password changed automatically.

It can be realized so that the machine allows to mill plastic elements composite of synthetic origin, rubber, high-density foam and other composite materials obviously including warheads the upper and lower panels of EPS in creating hollow corrugated surfaces with undercuts or dovetail groove, negative and positive in all its facades, and the male and female without constraints of depth and radius, necessary for a stacking of a plurality of elements for the specific embodiment of modular system in formwork transpirable “stay-in-place” thermo acoustic for building constructions ICF.

The main advantages against conventional machines that print the whole mass of mere rectangular blocks are not perfectly square in the four facades, are:
Density constant in all areas of the block (A), even if you want to incorporate high percentages of reclaimed material,
Uniform sintering of polystyrene foam, though not printed with beads virgins,
Low consumption of steam,
Low residual moisture content after crossing the molding cycle,
Vacuum tight’ and secure steam inside the mold parallelepiped, even if placed horizontally,
True ease of use and maintenance.

The software installed in the PC manages the operation of the machine (with modified block machine) and allows a diagnostic of any malfunction.

The standard dimensions of the mold may vary from a minimum of 1×0.5×1 m. up to a maximum of 8×1.25×1.5 m, and depending on the models are progressively adjustable in height or depth through the bank removable for sliding, driven by at least one hydraulic piston, or are calculable according to the needs of friction that creates for the expulsion of the block (A) pre-shaped parallelepiped.

As far as the technological-productive flexibility, the advantages are so numerous that the list can only be schematic:
The perfect features of selected aluminum alloys, and especially of alloys for High Speed milling (without imposing change frequently because of the modular matrices durable);
Consumption by abrasion of hard materials sintered and the same rectangular blocks tending to zero (compared to working on steel sides);
Almost total elimination of slow processes such as arthritis that are created during the ejection of the block (A) in EPS parallelepiped block. molding machine by vertical or horizontal;
Simplification of the budget and determined application of matrices micro-perforate “molds and figures” (only or mainly to scroll through the strips connected to the steel walls of conventional concrete block);
Implementation actual production (without interruption) molding and without interruption for cooling;
In general, significant increase in the speed of preparation of the counter-mold (made of micro modular aluminum) to be inserted into the mold of a conventional rectangular concrete block;
Advantages in terms of speed of construction, all the more remarkable, the higher is the volume of the counter-mold and the volume to be removed by conventional milling (construction of “molds”);
Troubleshooting cooling and related circuitry in an easy way: in fact, the same circuit is passing through the cavity of the strips attached horizontally to the wall of the conventional block machine, which in turn engage solidly in aluminum micro-perforated sheet metal of the matrix, where for many steels this is impossible (steel molds for more “insulation”);
Drastic reduction of time adjustment (due to lower bending stresses induced in the molding system of innovative rectangular blocks of EPS);
Drastic reduction of the time required for the surface polishing of the innovative against micro perforated matrices, both. manual or HSM.

The advantages compared to traditional systems are considerable:
Minimum space occupied;
Low noise level;
Complete absence of dust in the waste may therefore be recovered;
Reduced energy consumption;
Lower capital investment for the production of slabs with caves and gorges and “T” cross etc;
Considerable operational flexibility: the profile of the quarries and the flare and the thickness of the plates
It will be programmed by software applied to a PC without having to change any tools.

The same block (A) parallelepiped expanded polystyrene (EPS-PES) will be subjected to shear to simultaneously create multiple panels in. a very short time (ratio 1 to compared to the classic and known molding of panels ICF), depending on the requirement of thickness and extent in height and length; in turn, along the processing chain, such panels will be bound in a lane adjustable to size according to the measure of the panel, so that the drills at very high speed adjustable invention, as further application, able simultaneously milling the heads of the panels creating the necessary design as teeth, recesses or ribs negative and positive in order to stack them with a solid interlocking including through elongated elements, etc.

It is well to specify that’ the hot wire cutting of the panels in EPS not only allows to have an exclusive breathability due to its rough surface thus obtained by the procedure, which is still a further and exclusive advantage of adhesion to pairing of a plurality of ICF panels, in addition to being an ideal support to be. coated also with a traditional method, and having a guaranteed integral adhesion over time.

The method and the inventive pantograph described above therefore allow to considerably reducing the production costs of the panels ICF in EPS and conventional plates perfectly coplanar in both sides and homogeneous thickness.

Again, such panels can be printed without having to meet multiple constraints for their production, as for example, in the prior art called Insulated Concrete Forms, ICF, the fact of having to turn to indispensably large industries that have in use of specific machinery for their production.

With the inventive method, it is not difficult to find the raw material on site or in the immediate vicinity as the EPS blocks, with the obvious advantage of a simple stacking without lost volumes for their special rectangular shape, it becomes difficult to transport volumes finished materials, for long distances, being the same of different conformations and therefore not easily stackable without then transported volumes unnecessary.

Obviously that procedure in production site becomes purely economic and, it goes without saying that at the same time innovative production process on site, contributes to the total respect of the environment, and yet, the inventive technology not only performs extremely unique and innovative, but also respects also the environment with a much lower pollution due to transport to the total volume of the semi-finished product, resulting in more economic in each type of processing in comparison with the conventional panels. for ICF printed via specific molds by type.

An application example of the inventive method is described below. 20 blocks/hour were used with density 15 g/lt and dimensions 600×1,200×4,000 millimeter, whereby during molding were obtained about 1060 sheets, panels ICF thickness of 75 millimeter, with facades representing the figures volutes, as continuous ribs horizontally (ribs modular necessary for the stacking of a plurality of panels) only to be cut in the top and bottom surfaces with the appropriate dovetail slots “T”—cross or other representations without limitation by the pantograph amended of the present invention.

The ratio of cut slabs of panels ICF in comparison to the classic known molding was 1 to 9, and therefore are evident its effectiveness, as well as its industrialization easy and economical, thanks to the limited necessary equipment, except that implementation of machinery from always existing.

As a comparative example, we used a classical and conventional aluminum mold with four figures (four panels ICF without co-molded plastic inserts), having an average of 2.5/3.0 minutes for printed for simple plates or panels containing ICF longitudinal slots at half height of the panel ICF.

Obviously, taking into account the 2.5/3.0 minutes cited, they are printed with such a conventional mold in aluminum 24 panels ICF: therefore, in order to achieve the same quantity obtained by the above-mentioned process of the invention, it would take at least. 44 hours with such conventional mold.

According to a variation not shown, on the base of the Machine 1 are arranged (by screwing or welding certified) devices to cylindrical or polygonal hole for insertion of gripping means of an arm interchangeable shaped for the purpose, which moves by means of hydraulic cylinders or winch, is interchangeable devices that depend on the conformation of the towing vehicle, by satisfying all conditions, even, the most disparate, act on a trailer and shaped for the purpose, which is also extensible and extending through an integrated frame to the chassis primary.

Once inserted the gripping members through specific hooks, by means of a hydraulic cylinder or a winch, the machine undergoes a rotation of at least 90°, but not bound to other inclinations necessary, without limits of inclination, an essential element not to exceed the overall height of 4 meters height of the road surface, and the maximum permitted height worldwide.

Subsequently, and of course by means of the hydraulic cylinder or via a manual winch or winch, the Machine 1 is moved into position so as to fall in the original shape of the trailer, both in width, both in height and in length. Obviously, in the frame of the trailer, there is a mechanism with kinematic mechanism which is inserted in the slots of the longitudinal frame for the securing and locking of the machine itself.

According to a variation not shown for the production of moldings and decorative elements, even with the more complex forms, the base of. the machine 1 is constituted by at least one plane which is blocked with clashes adjustable. The work piece or the semi-finished element is always obtained from a known parallelepiped block polystyrene EPS or other foamed materials, placed horizontally. For each longitudinal side is placed a cross slide through turbulent kinematic (rails, pads, pulleys and belts, ball screws, motors). On the slide is positioned an arm with two shoulders, rotating, by means of a gear motor carrier shaped wire “U” to perform the shaping of the cornice and/or of the decorative element; on the sled is positioned an arm with two shoulders, a carrier die or hot foil pre-shaped, and shaped for the specific purpose, to perform the grooves dovetail, “T”, cross or hollow circular or’ semicircular radiuses for housing the connectors in (PP) polypropylene or corrugated steel for construction. On the above cross slides can be implemented also additional devices such as electro-spindles milling and/or other rotating arms and not, load-bearing wires and cutting dies or hot foil stamping suitably shaped for the purpose, in order to obtain the decorations monolithic even the most disparate. Everything is always managed by the CNC system. On the. floor of the machine, not shown but similar to the devices previously described, are placed electro-pneumatic cylinders equipped with ball-bearing rod end, to raise the block from the floor so that the machining tool is complete, it being understood that the same spheres will not interfere with the cutting tools, wire dies, and hot foil stamping.

According to a variation application of the lathe, not shown, the CNC allows you to create accurately the various profiles, providing endless possibilities for aesthetic and architectural solutions to the designer to enhance the final work, and capitals, columns, pilasters, eaves string course, and the constitutive forms of an architectural facades, doors, windows, etc. and formwork for any type of bow and time: arches, segmental arches, polycentric and elliptical vaults, cloister vaults, •barrel vaults, and any decorative element also complex and in many different forms.

On the base of the machine 1, is to have a support tailstock rotating even in neutral manually movable in the longitudinal direction, and a fixed support tailstock rotary driven by a motor (or by pulleys, belts), through which said mechanism can rotate around its axis at a predetermined speed depending on the needs of the element to be produced in a short time with obvious economies of scale. The tailstocks are constituted by a ring carrying a series of cone tips which penetrate into the material and inhibit slippage of the element semi-synthetic material or plastic, preferably expanded polystyrene without limit density. The same purpose can be obtained with a punch shaped hot depending on the purpose, which penetrates in the block semi-finished product and of course by friction prevents slippage. On one longitudinal side there is disposed a cross slide moved through kinematic. motions described previously (rails, shoes, pulleys and belt, ball screws, motors). On the slide can be mounted one or more devices to drill and/or hot wire described above. In the drawing is shown a device to cutter mounted on a three axis mechanism (in addition to the cross table (axes X, Y), always by means 10,11,12 exists also the translation in Z); since the machine is controlled by CNC, the rotation movement can be continuous and/or interpolated (C axis) with Z, Y, Z.

According to a variation with panel tongued checkers, and recesses negative/positive (not illustrated), this is one of the many conformations obtainable, more preferably at drafts of two sides of the panel, characterized by empty and full alternated as low as 2.5 centimeter and its possible multiples and submultiples to obtain perfect joint, superimposition of a plurality of panels, or the same may have the peculiar characteristic of cross up to 90° angle to create perfect (from thermal bridges free) for walls geometry variable double skin insulation, preferably polystyrene EPS; this specific machining is achieved by means of a frame moved to CNC system on three axes X, Y, Z by means of the kinematic mechanisms described, consisting of a support made of insulating material (for example Bakelite and other insolated), while the same houses and binds through slots placed in multiple measures that ensure perfect registration of the hot-wire shaped. The blocking of panels, arranged on the floor of the machine and locked by clashes recordable (not shown) is penetrated by the hot die with sequential action according to the axes Y, Z and then finally again in Y direction opposite to the initial one. The movement along X serves to complete the processing of the panels ICF throughout their length.

The Machine (1) can be combined with a block molding machine-producing parallelepiped blocks known for its static production of parallelepipeds not coplanar in its four longitudinal facades. In the conventional block machine, the innovation consists in the particular frame expandable laterally through hydraulic cylinders, to be introduced in a block molding machine conventional of the internal structure. On the sides of the movable frame can be fixed advantageously and easily, via slides, a series of plates (even only one for the whole surface as shown in the drawing for simplicity) that realize one of many conformations (for example the parallelepiped in EPS has the same facade having the shape of a lady (recesses negative and positive modular) linear or swing male and female without constraints deep into the recesses thus obtained). In the fixed part opposite’ to the door are fixed a series of plates (even only one for the whole surface as shown in the drawing for simplicity) that realize the conformation grooves; in this wall are surrounded and formed also pushers (known elements) for the ‘extraction of block polystyrene EPS after the expansion has occurred and sintering of the beads in the EPS through the steam injected—through specific pads micro-perforated modularly integrated into the plates or modular elements pre-shaped, or the pads may be replaced by micro-cuts made by laser, obviously necessary for the passage of steam for the sintering of the block in EPS. The same system described with the same shape is applied to the floating gate but without pushers.

After the cycle of expansion and sintering, which lasts about 6/7 minutes, for the outflow of the block in EPS pre-shaped in the facades block machine is opened, the hydraulic cylinders open the frame and the block in EPS is ejected smoothly in order to then be place in the machine modified in order for the cutting of the panels in the desired thickness and shape of the dovetails in both sides.

What is claimed is:

1. A compact CNC machining center equipped with hot cutting blades and pre-shaped punches with an integrated hot wire and drills, for machining extruded or expanded materials in general, comprising:
at least a first station (1) comprising:
at least one castle (1′) adapted to contain at least one block (A) of expanded polystyrene, EPS, for processing;
at least one frame (5) adapted—to carry at least one cutting die (6), said dies (6) being fixed or movable in order to adapt to the thickness of the panel to be realized from said block (A) and cutting it;
at least two slides (14) for milling performed by a tool (15) mounted on at least one electro-spindle (16) for each slide (14), said milling tool (15) being adapted to move in interpolation along vertical and horizontal directions so as to perform an inclined milling and/or according to a curvilinear profile, and
at least one frame (20) carrying wires (21) complete with insulators (22) and devices (23) for fixing and tensioning wires (21), said wires (21) being adapted to move in interpolation along vertical and horizontal directions in order to perform an inclined cut and/or according to a specific curvilinear profile; characterized in that, above said cutting dies (6), unheated metallic foils are placed, having the same shape. of the hot cutting dies (6), adapted to prevent the narrowing of the opening of the panel immediately after passing through the hot cutting dies (6), so as to prevent an increase of resistance to cutting and any change of direction of the panel.

2. The compact CNC machining center according to claim 1, characterized in that said castle (1′) is constituted by vertical uprights having longitudinal grooves supported by a base (2) which houses a. supporting surface (3) equipped with electro-pneumatic cylinders (4), and further comprises a carriage door-frame (9) that slides on linear guides (10) placed inside the uprights (1′) and is moved in the vertical direction, by means of a transmission screw (11) or even with pulleys and belt, —and a motor (12).

3. The compact CNC machining center according to claim 2, characterized in that, on said carriage (9), an handling system is placed which allows the frame (5) to move in the horizontal direction to escape from the castle (1′) so as to be positioned manually according to an angle from 0° to 90° thanks to a hinge graduated (13) interposed between the carriage (9) and the frame (5) for performing cutting along directions as desired.

4. The compact CNC machining center according to claim 1, characterized in that the slides (14) opposing slide on linear guides (17) of known construction placed outside of the uprights (1′) and that are handled in the vertical direction, by means a transmission screw (18) or even with pulleys and belt, and motor (19).

5. The compact CNC machining center according to claim 1, characterized in that said wires (21) are fixed or movable manually or by a motor drive, to adapt to the cutting to be performed, said carriage (24) which bears the frame (20) sliding on linear guides (25) placed outside of the uprights of castle (1′) and being moved in a vertical direction, by means of a screw driver (26) or even with pulleys and belt, and motor (27).

6. The compact CNC machining center according to claim 1, characterized in that, for the maintenance of the cut panels on the sides of the castle (1′) opposite the entrance and exit of the block (A) in EPS, are arranged in the vertical direction of the cylinders electro-pneumatic equipped end of the stem of pointed appendages (28) or suction cups (29), acts to intervene, CNC controlled, only after the passage of the frame (5) carrying hot cutting dies (6) and to turn off at the end of all machining.

7. The compact CNC machining center according to claim 1, characterized in that it further comprises gripping devices adapted to grip, starting from the top, the panels that are completely processed to evacuate them from the working area.

8. The compact CNC machining center according to claim 1, characterized in that it further comprises, in the upper part of the bunk {1′), a suction hood (30) of the fumes generated by the hot cutting dies (6) and wire and a counter-hood (31) for maintaining constant the temperature of the hollow punches and hot wire (21).

9. The compact CNC machining center according to claim 1, characterized in that it further comprises at least one mechanism (32) to translate and tilt for the group of panels, which is brought into a second station (33) where, through mechanisms of milling (34) and (35), said panels are subjected to milling to achieve the grooves on the sides; said at least one mechanism (32) to translate and tilt consists of gripping arms self-centering by means of electro-pneumatic cylinders, translating always by means of electro-pneumatic cylinders, and facts rotate through electro-pneumatic rotary cylinder.

10. The compact CNC machining center according to claim 9, characterized in that it further comprises, after said second station (33), thrust mechanisms of a carpet or roller conveyor (36). where, through the mechanisms (37) and (38), said panels undergo the execution of other processes; said mechanisms (37) and (38) are each constituted by a rotating arm by a (0°-180°) motorized carrying one or more electro-spindles mechanically adjustable in position along the direction of the arm itself to vary the geometry of the machining, said arms, in addition to the rotation, being equipped with a movement parallel and perpendicular to the direction of the belt or roller conveyor (36) by means of motorized mechanisms.

11. The compact CNC machining center according to claim 1, characterized in that said first station (1) is realized as. a first station (1′!′) without kinematic hot cutting dies (6) and multiple wire/s (21) with kinematic milling on all four sides for the realization of grooves, emptying and decorations on a block (a) entire, previously cut panels and other architectural elements such as columns, capitals, etc., the support table of the material being rotatable and all movements being controlled by CNC system.

12. The compact CNC machining center according to claim 20, characterized in that the supports (39) leads electro-spindles (40) are independent of each other, are arranged vertically with manual mechanical variation of distance between the one and the other, and are moved by means of kinematic mechanisms (42) of handling.

13. The compact CNC machining center according to claim 1, characterized in that said first station (1) is realized as a first station (UV) only with kinematic hot cutting, dies (6) multiple for the execution of the emptying of a column and with a support (43) that leads cutters (44) arranged vertically, with manual mechanical variation of distance between the one and the other, driven by belt and pulleys by a single motor, said support being moved by kinematic linear or angular (46) by means of rack and pinion for the execution of the decorations on the above column without limitation working at any angle and depth.

14. The compact CNC machining center according to claim 1, characterized in that said first station (1) is realized as a first station (IV) only with multiple kinematic hot cutting dies (6) for the execution of the emptying from one to four columns of conformation and different design, equipped with dovetail grooves and slots “T” or “cross” for housing any type of connector is necessary for the conjunction of the semi-columns and the housing bound the longitudinal rods and the stirrups horizontal variable pitch, the elements obtained by cutting and emptying having the function of keep-disposable-caissons or formwork for building constructions.

15. The compact CNC machining center according to claim 1, characterized in that, on the base of the machine (1) devices are arranged in cylindrical or polygonal hole for insertion of gripping means of an arm interchangeable, which moves by means of hydraulic cylinders or winch which depend on the conformation of the towing vehicle, of a trailer extensible and extending through an integrated frame to the chassis primary.

16. The compact CNC machining center according to claim 1, characterized in that the base of the machine (1) is constituted by at least one plane which is blocked with clashes, and, for each longitudinal side, there is disposed a cross slide moved through the kinematic mechanisms (10, 11, 12), the slide being positioned an arm with two shoulders, rotating by means of a gear motor carrier shaped wire “U” to perform the shaping of the cornice and/or of the decorative element, the slide being positioned an arm two shoulders, supporting a die or hot foil shaped to perform the grooves dovetail, “T”, —cross or hollow circular or semicircular radiuses for housing the connectors in (PP) polypropylene or steel. ▪

17. The compact CNC machining center according to claim 25, characterized in that one said cross slides are implemented also additional devices such as electro-spindles milling and/or other rotating arms and non-load bearing wires and cutting dies or hot foil stamping, all managed by the CNC system, or, on the floor of the machine, are placed electro-pneumatic cylinders equipped with ball-bearing rod end, to raise the block from the floor so that the machining tool is complete, said balls not interfering with cutting tools wire, blades—punching tools, and hot foil stamping.

18. The compact CNC machining center according to claim 1, characterized in that, on the base of the machine 1, are located in a support tailstock, also rotating in neutral manually movable in the longitudinal direction, and a fixed support tailstock rotary driven by a geared motor, or by pulleys and belts, through which said mechanism can rotate around its axis at a predetermined speed depending on the needs of the element to be produced in a short time; the mating centers are constituted by a ring carrying a series of cone tips which penetrate into the material and inhibit slippage of the element semi-finished plastic material, or a die hot suitably shaped to Depending on the purpose, which penetrates in the block foam semi finished product and of course by friction prevents slippage; and on one longitudinal side, there is disposed a cross slide moved through the kinematic mechanisms (10, 11, 12), the slide being mounted one or more devices to the cutter and/or wire hot.

19. The compact CNC machining center according to claim 1, characterized in that it further comprises a specific frame expandable laterally through hydraulic cylinders, to be introduced in a block molding machine—to coating of the Internal structure, on the sides of the movable frame being fixed, by means of slides, at least one plate which realizes one of the conformations, in the fixed part opposite to the door being fixed to at least one plate which realizes the conformation grooves, in this wall being surrounded and formed also pushers for the extraction of the block polystyrene EPS after the expansion has occurred and sintering of the beads EPS through the steam injected through specific pads micro-perforated modularly integrated into the plates or modular elements pre-shaped, the pads being substituted by micro-cuts, required for the passage of steam necessary for the perfect and homogeneous sintering system of the block in EPS.
